(19) United States
(12) Patent Application Publication
(10) Pub. No.: US 2026/0210521 A1
(43) Pub. Date: Jul. 23, 2026

(54) LED VEHICLE HEADLAMP CAPABLE OF MULTI SIDED EMISSION

(71) Applicant: Dongguan G-View Lighting Technology Co., Ltd, DongGuan (CN)

(72) Inventors: Wei Qu, DongGuan (CN); Defa Wu, DongGuan (CN); Tianji You, DongGuan (CN)

(21) Appl. No.: 19/450,989

(22) Filed: Jan. 16, 2026

(30) Foreign Application Priority Data
Jan. 21, 2025 (CN) 202520146817.3

(51) Int. Cl. F21S 45/42; F21S 41/148

(52) U.S. Cl. CPC F21S 45/42; F21S 41/148

(57) ABSTRACT

An LED vehicle headlamp capable of multi-sided emission comprises a lamp body, a driver assembly, a first light source board having first and second emitting surfaces, and a first fan structure disposed in the lamp body for cooling the first light source board. A second light source board capable of emitting light is provided on the first light source board; when the driver assembly energizes the first light source board, the second light source board lights synchronously to illuminate a dark region between the first and second emitting surfaces. By adding the second light source board at an upper end of the first light source board, a region perpendicular to and between the two emitting surfaces is filled. The second light source board illuminates in low-beam and high-beam modes, thereby eliminating shadowing, improving uniformity of emitted light, and providing a simple structure suitable for widespread application in automotive headlamps.

### CROSS-REFERENCE TO RELATED APPLICATIONS

This application claims priority to Chinese Patent Application No. 202520146817.3, filed on January 21, 2025, which is hereby incorporated by reference in its entirety.

### TECHNICAL FIELD

The present disclosure relates to the technical field of automobile parts, and more particularly to an LED vehicle headlamp capable of emitting light from multiple sides.

### BACKGROUND

LED headlamps have been increasingly adopted in the market. Compared with traditional light sources, LED luminaires offer higher luminous efficacy, lower energy consumption, longer service life, and improved environmental performance. With rapid growth of the automotive industry and rising consumer expectations, LED technology has been gradually replacing halogen and xenon lamps to become a mainstream choice for modern vehicle lighting.

Most commercially available LED headlamps employ a two-sided emitting structure in which both sides of the light source board carry low-beam and high-beam LED chips. For example, Chinese Utility Model CN221923173 U discloses an LED vehicle headlamp with explosion-proof functionality, in which a fan drives airflow through a collection member and a delivery tube into a reflector housing to cool the LED body. While this improves thermal management, two-sided light source boards remain limited by the LED chip emission angle (typically about 120°) and by occlusion from the board itself. As a result, regions perpendicular to the board can fall into shadow, producing dark zones in the projected beam pattern and non-uniform illumination.

To overcome the foregoing drawbacks, the inventor proposes the following solution .

### SUMMARY

Disclosed is an LED vehicle headlamp capable of multi-sided emission. The headlamp comprises: a lamp body; a driver assembly disposed within the lamp body; a first light source board disposed within the lamp body and driven by the driver assembly to emit light, the first light source board having a first emitting surface and a second emitting surface; and a first fan assembly disposed within the lamp body for cooling the first light source board. A second light source board capable of emitting light is provided on the first light source board. When the driver assembly energizes the first light source board, the second light source board lights simultaneously to illuminate a dark region between the first emitting surface and the second emitting surface.

In one aspect, the driver assembly includes a driver board and a driver adapter board laterally inserted into the driver board and electrically connected to the first light source board. The driver adapter board defines a connecting slot, and the first light source board forms a mating connecting projection. A plurality of first connection contacts are disposed on both sides of the connecting slot, and a plurality of corresponding second connection contacts are provided on the connecting projection.

In another aspect, a second cooling fan is disposed below the driver adapter board to exhaust heat/air from the interior of the lamp body. A cooling copper tube is arranged in the lamp body. The lamp body forms a recessed copper-tube locating groove for receiving the cooling copper tube. One end of the cooling copper tube extends below the first light source board and the other end extends below the second cooling fan.

In another aspect, the second light source board is provided with supplementary LED chips for illumination and is disposed substantially perpendicular to the first light source board. The second light source board defines an avoidance slot that snap-fits to the connecting projection of the first light source board.

In another aspect, the first fan assembly includes a fan adapter plate connected to the first light source board and a heat-exhaust fan driven via the fan adapter plate. The first light source board forms an adapter projection for connection with the fan adapter plate, and the fan adapter plate defines an adapter mounting hole.

In another aspect, a plug is provided on the lamp body. The plug includes a plug plate and a plurality of metal pins passing through the plug plate. Each metal pin forms a connection segment that passes through the plug plate and is connected to the driver assembly.

In another aspect, the lamp body includes a plurality of first locking screws, a first lamp housing, a second lamp housing secured to the first lamp housing by the first locking screws, a plurality of second locking screws, and a pressing block secured to the second lamp housing by the second locking screws.

In another aspect, low-beam and high-beam LEDs are arranged as follows: the first emitting surface carries first low-beam LEDs and first high-beam LEDs; the second emitting surface carries second low-beam LEDs and second high-beam LEDs.

In another aspect, the first lamp housing defines a first clearance opening through which the first low-beam LEDs and first high-beam LEDs are exposed; the second lamp housing defines a second clearance opening through which the second low-beam LEDs and second high-beam LEDs are exposed.

In another aspect, the second lamp housing further defines a second threaded hole. The pressing block defines a pressing-block through-hole. The second locking screw passes through the pressing-block through-hole and is threaded into the second threaded hole to fasten the pressing block. The pressing block defines heat-dissipation holes and further extends to form a limiting cap portion that limits/retains the second light source board.

By adding the second light source board at the upper end of the first light source board, the dark zone perpendicular to and between the first emitting surface and the second emitting surface is filled. Unlike conventional structures, the second light source board lights for both low-beam and high-beam operation, effectively eliminating low-/high-beam shadowing and improving emission uniformity with a simple structure suitable for widespread application in various automotive headlamps.

### BRIEF DESCRIPTION OF THE DRAWINGS

FIG. 1 is a perspective structural view of the disclosed headlamp;

FIG. 2 is an exploded structural view of the disclosed headlamp;

FIG. 3 is an exploded view of the lamp body;

FIG. 4 is a structural view of the first light source board;

FIG. 5 is a structural view of the driver adapter board;

FIG. 6 is a structural view of the fan adapter plate;

FIG. 7 is a structural view of the second light source board;

FIG. 8 illustrates the emission angle of a prior-art light source board;

FIG. 9 illustrates emission angles of the first and second light source boards of the present disclosure.

### DESCRIPTION OF EMBODIMENTS

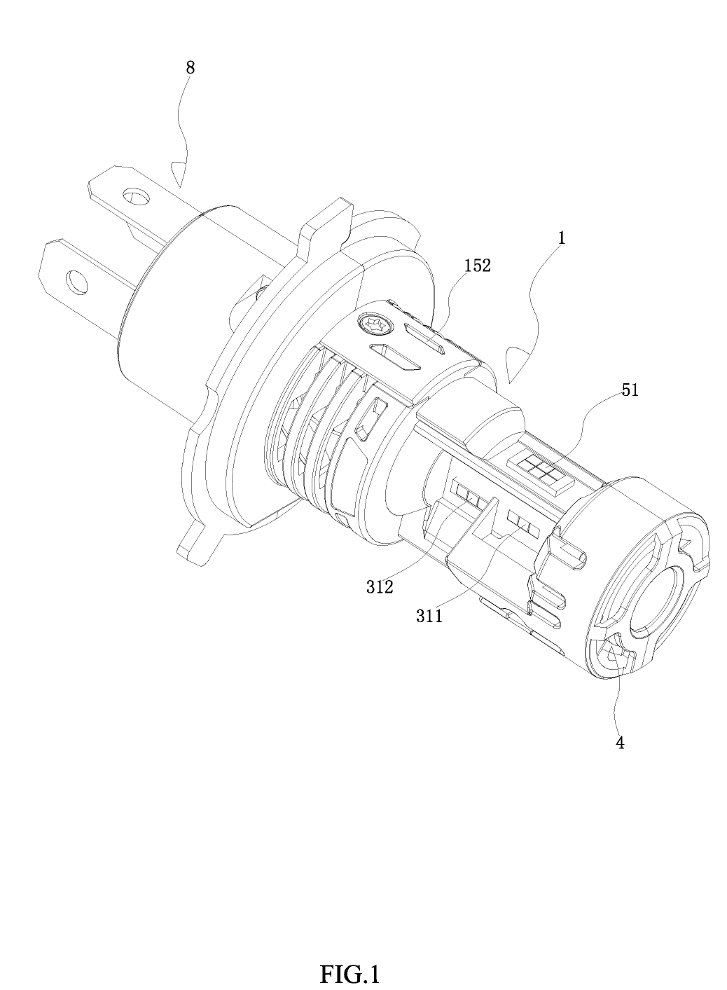

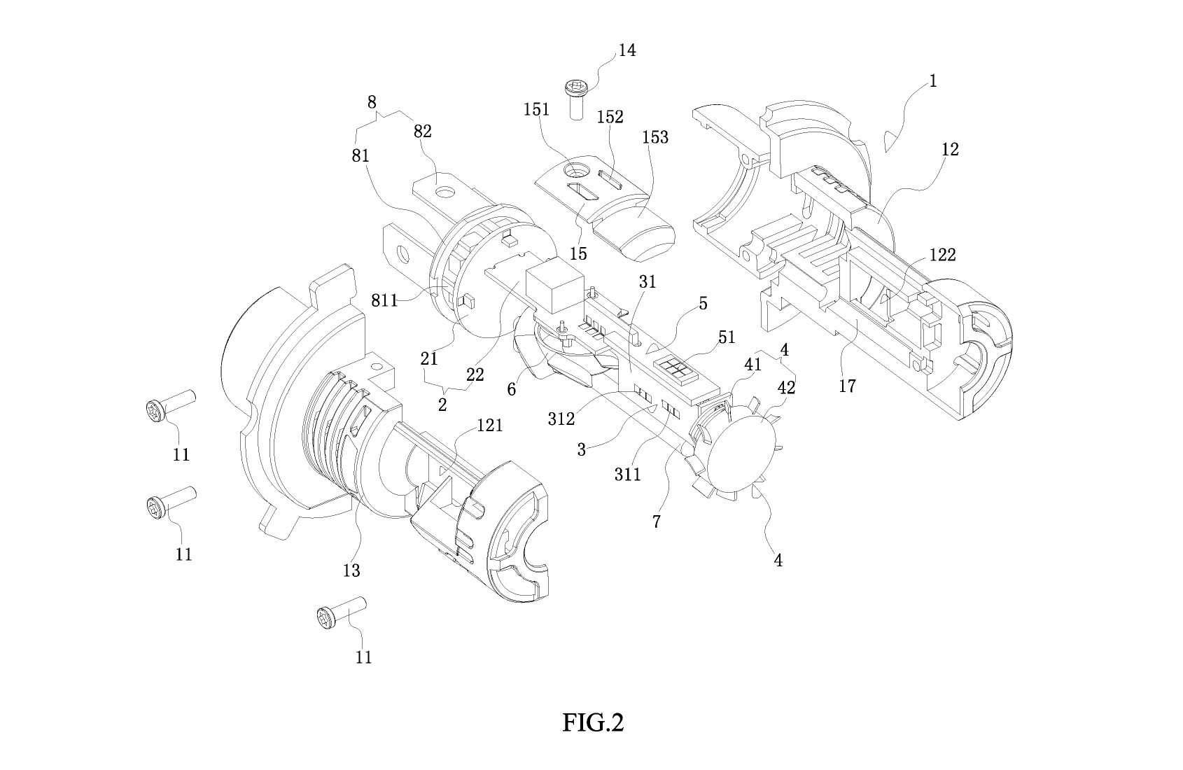

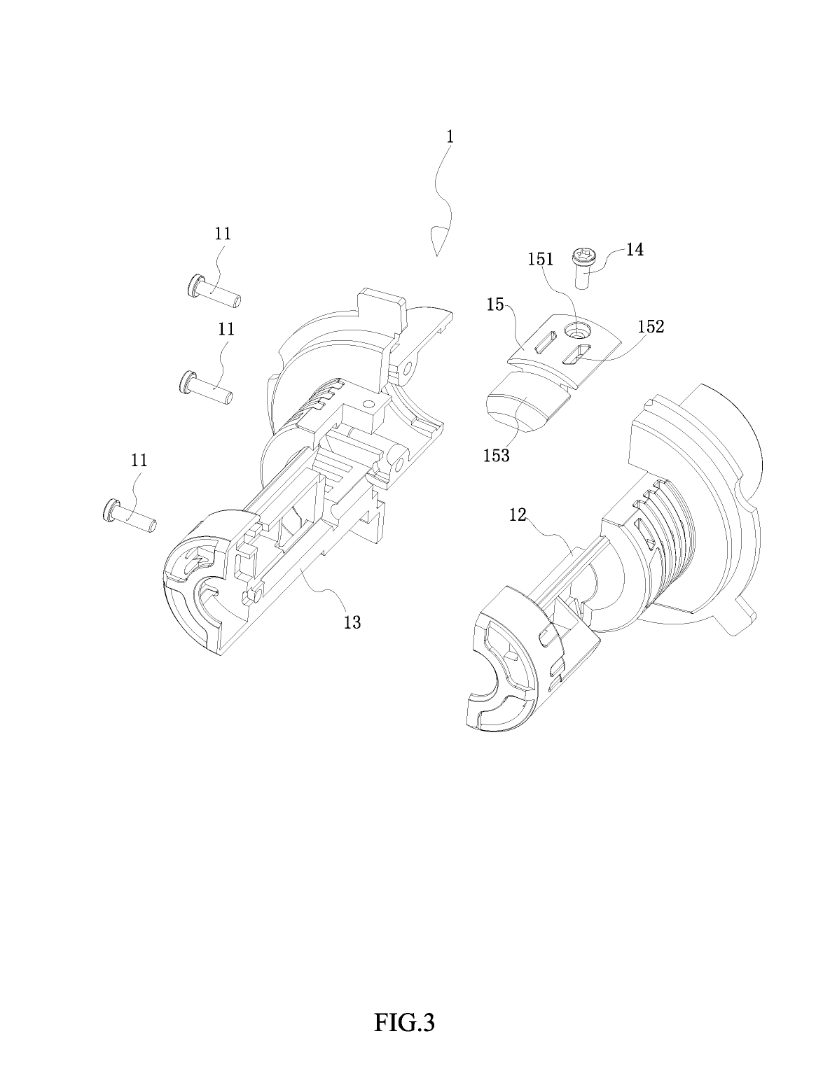

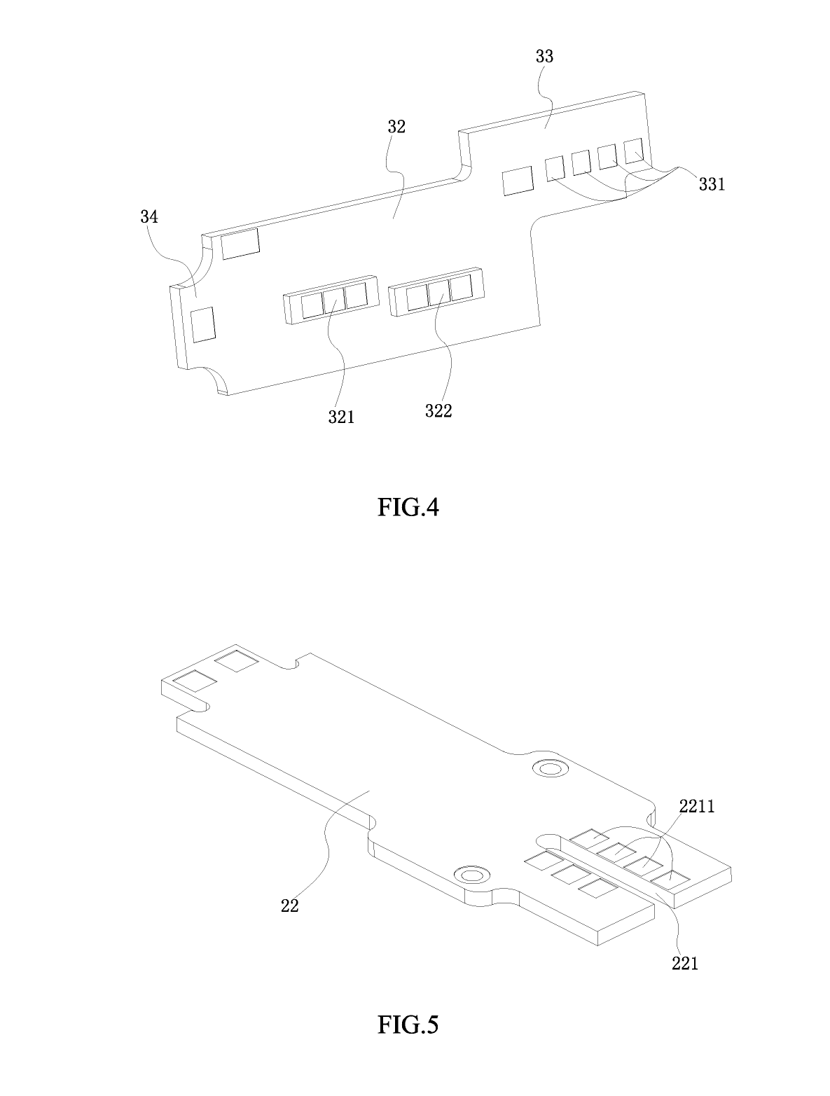

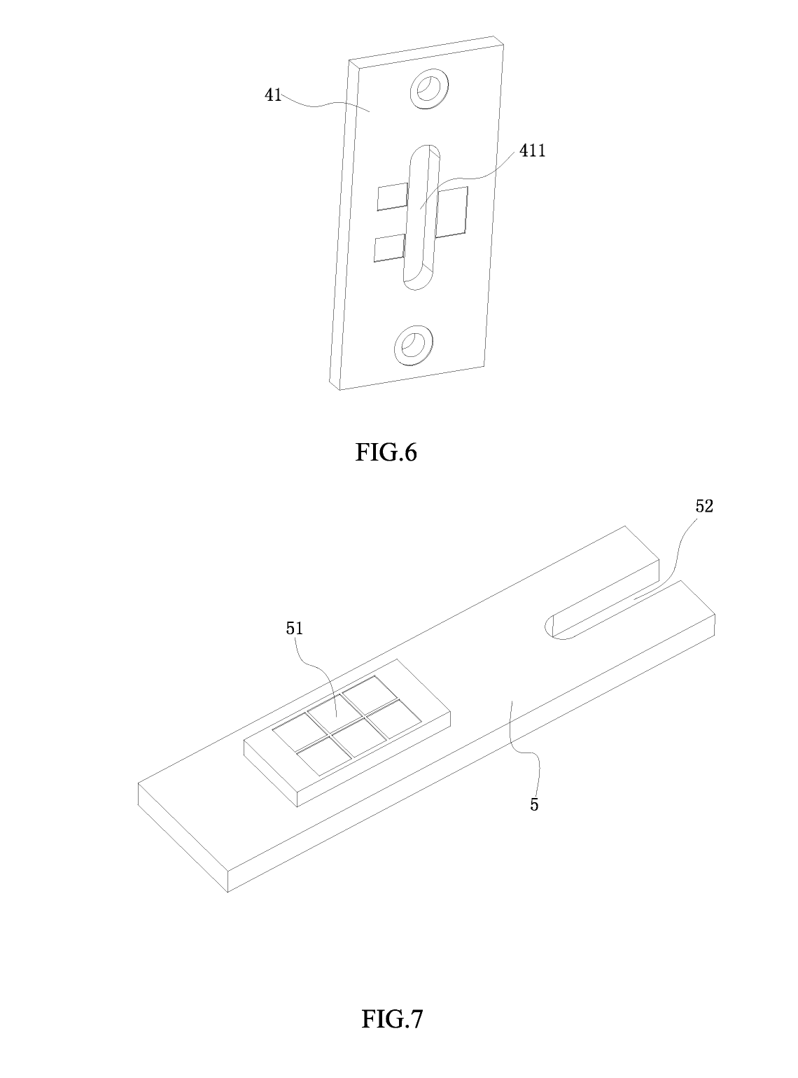

With reference to FIGS. 1-9, an LED vehicle headlamp capable of multi-sided emission includes a lamp body (1), a driver assembly (2) disposed in the lamp body (1), and a first light source board (3) disposed in the lamp body (1) and driven by the driver assembly (2) to emit light. The first light source board (3) has a first emitting surface (31) and a second emitting surface (32). A first fan assembly (4) is disposed in the lamp body (1) to cool the first light source board (3). A second light source board (5) capable of emitting light is provided on the first light source board (3). When the driver assembly (2) turns on the first light source board (3), the second light source board (5) turns on simultaneously to illuminate the dark region between the first emitting surface (31) and the second emitting surface (32).

By arranging the second light source board (5) above the first light source board (3), the dark region perpendicular to the first and second emitting surfaces (31, 32) is complemented. The second light source board (5) illuminates in both low-beam and high-beam modes, thereby solving shadowing in either mode, improving uniformity of emission, and providing a simple structure applicable to various automotive headlamps.

The lamp body (1) includes a plurality of first locking screws (11), a first lamp housing (12), a second lamp housing (13) fastened to the first lamp housing (12) by the first locking screws (11), a plurality of second locking screws (14), and a pressing block (15) fastened to the second lamp housing (13) by the second locking screws (14). A plug (8) is further provided on the lamp body (1). The plug (8) includes a plug plate (81) and a plurality of metal pins (82) passing through the plug plate (81). Each metal pin (82) forms a connection segment (811) that passes through the plug plate (81) and is connected to the driver assembly (2). After the metal pins (82) pass through the driver assembly (2), they are soldered in place. When the metal pins (82) are electrically connected to an external receptacle, power is conducted directly to the driver assembly (2).

The driver assembly (2) includes a driver board (21) and a driver adapter board (22) laterally inserted into and soldered to the driver board (21), the driver adapter board (22) being electrically connectable to the first light source board (3). The driver adapter board (22) defines a connecting slot (221), and the first light source board (3) forms a mating connecting projection (33). A plurality of first connection contacts (2211) are disposed on both sides of the connecting slot (221), and corresponding second connection contacts (331) are disposed on the connecting projection (33). In use, the connecting projection (33) extends into the connecting slot (221). After aligning the first connection contacts (2211) with the second connection contacts (331), the contacts are soldered to establish electrical continuity. When the plug (8) is electrically connected to an external receptacle, the driver board (21) conditions and converts the input and delivers control signals via the driver adapter board (22) to the first light source board (3) to control on/off and low-beam/high-beam switching.

The second lamp housing (13) defines a second threaded hole (131). The pressing block (15) defines a pressing-block through-hole (151). The second locking screw (14) passes through the pressing-block through-hole (151) and threads into the second threaded hole (131) to fasten the pressing block (15). The pressing block (15) further defines heat-dissipation holes (152) and extends to form a limiting cap portion (153) that bears against and limits the second light source board (5). After the second light source board (5) is soldered to the first light source board (3), the pressing block (15) enhances stability and prevents vibration during vehicle operation from causing the second light source board (5) to shake or disengage.

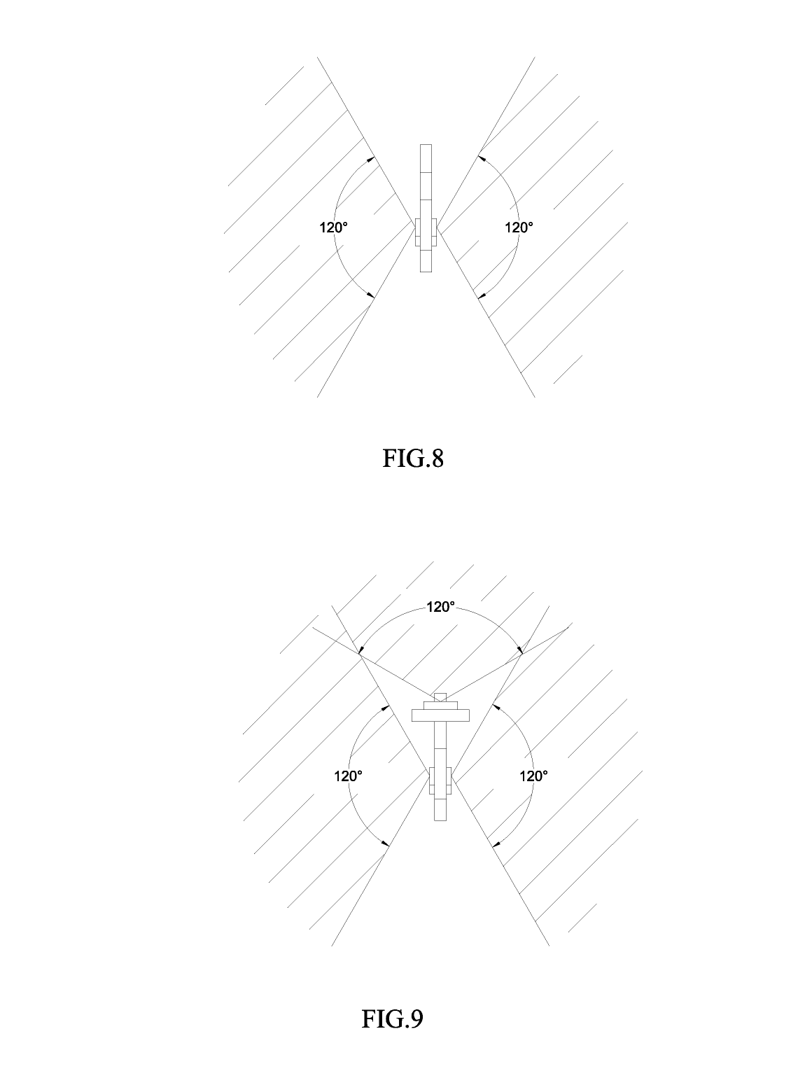

The second light source board (5) is provided with supplementary LED chips (51) for emission and is disposed substantially perpendicular to the first light source board (3). The second light source board (5) forms an avoidance slot (52) that snap-fits with the connecting projection (33) of the first light source board (3), providing preliminary positioning before solder reinforcement. As shown in FIGS. 8 and 9, with typical LED chip emission angles of about 120°, arranging the second light source board (5) above the first light source board (3) effectively fills the dark region that would otherwise exist between the two emitting surfaces.

A second cooling fan (6) is disposed below the driver adapter board (22) to exhaust heat generated inside the lamp body (1), particularly heat from the driver assembly (2). A cooling copper tube (7) is arranged in the lamp body (1). The lamp body (1) forms a copper-tube locating groove (17) for receiving the copper tube (7). One end of the copper tube (7) extends below the first light source board (3), and the other end extends below the second cooling fan (6), thereby enhancing heat transfer and improving cooling efficiency relative to conventional layouts.

The first fan assembly (4), positioned proximate to the first light source board (3), includes a fan adapter plate (41) connected to the first light source board (3) and a heat-exhaust fan (42) driven via the fan adapter plate (41) to dissipate heat from the first light source board (3). The first light source board (3) forms an adapter projection (34) for connection to the fan adapter plate (41), and the fan adapter plate (41) defines an adapter mounting hole (411).

The first emitting surface (31) carries first low-beam LEDs (311) and first high-beam LEDs (312). The second emitting surface (32) carries second low-beam LEDs (321) and second high-beam LEDs (322). The first lamp housing (12) defines a first clearance opening (121) through which the first low-beam LEDs (311) and first high-beam LEDs (312) are exposed. The second lamp housing (13) defines a second clearance opening (122) through which the second low-beam LEDs (321) and second high-beam LEDs (322) are exposed.

In summary, by providing the second light source board (5) above the first light source board (3), the headlamp fills the dark region between the two emitting surfaces, enables both low-beam and high-beam operation without shadowing, improves uniformity of illumination, and maintains a simple structure suitable for broad application in vehicle headlamps.

It will be understood that the embodiments described above are illustrative and not limiting. Various equivalent changes or modifications made on the basis of the structures, features, and principles described herein shall fall within the scope of protection of the appended claims of the present application.

What is claimed is:

1. An LED vehicle headlamp capable of multi-sided emission, comprising:
a lamp body;
a driver assembly disposed within the lamp body ;
a first light source board disposed within the lamp body and driven by the driver assembly to emit light, the first light source board having a first emitting surface and a second emitting surface; and
a first fan structure disposed within the lamp body for dissipating heat from the first light source board;
wherein a second light source board capable of emitting light is provided on the first light source board, and when the driver assembly turns on the first light source board, the second light source board lights synchronously to illuminate a dark region between the first emitting surface and the second emitting surface.

2. The LED vehicle headlamp according to claim 1, wherein the driver assembly comprises: a driver board; and a driver adapter board laterally inserted into the driver board and configured to electrically connect to the first light source board; the driver adapter board defining a connecting slot, and the first light source board forming a mating connecting projection; wherein a plurality of first connection contacts are disposed on both sides of the connecting slot, and a plurality of corresponding second connection contacts are disposed on the connecting projection.

3. The LED vehicle headlamp according to claim 2, wherein a second cooling fan is disposed below the driver adapter board to discharge hot air and heat from an interior of the lamp body to the outside; and wherein a cooling copper tube is provided in the lamp body, the lamp body being recessed to form a copper-tube locating groove configured to receive the cooling copper tube, a first end of the cooling copper tube extending beneath the first light source board, and a second end of the cooling copper tube extending beneath the second cooling fan.

4. The LED vehicle headlamp according to claim 3, wherein the second light source board is provided with supplementary LEDs for illumination, is disposed substantially perpendicular to the first light source board, and defines an avoidance slot configured for snap-fit engagement with the connecting projection of the first light source board.

5. The LED vehicle headlamp according to claim 1, wherein the first fan structure comprises a fan adapter plate connected to the first light source board and a heat-exhaust fan driven via the fan adapter plate to dissipate heat, the first light source board protrudingly forming an adapter projection for connection with the fan adapter plate, and the fan adapter plate defining an adapter connecting hole.

6. The LED vehicle headlamp according to claims claim 1, wherein the lamp body further comprises a plug including a plug plate and a plurality of metal pins extending through the plug plate, each metal pin forming a connection segment that passes through the plug plate and is connected to the driver assembly.

7. The LED vehicle headlamp according to claim 6, wherein the lamp body comprises a plurality of first locking screws, a first lamp housing, a second lamp housing fastened to the first lamp housing by the first locking screws, a plurality of second locking screws, and a pressing block fastened to the second lamp housing by the second locking screws.

8. The LED vehicle headlamp according to claim 6, wherein the first emitting surface is provided with first low-beam LEDs and first high-beam LEDs, and the second emitting surface is provided with second low-beam LEDs and second high-beam LEDs.

9. The LED vehicle headlamp according to claim 8, wherein the first lamp housing defines a first clearance opening through which the first low-beam LEDs and the first high-beam LEDs are exposed, and the second lamp housing defines a second clearance opening through which the second low-beam LEDs and the second high-beam LEDs are exposed.

10. The LED vehicle headlamp according to claim 9, further comprising: a second threaded hole formed in the second lamp housing; a pressing block defining a pressing-block through-hole; and a second locking screw passing through the pressing-block through-hole and threaded into the second threaded hole to fasten the pressing block; wherein the pressing block defines heat-dissipation holes and further extends to form a limiting cap portion configured to limit the second light source board.
